(19) United States
(12) Patent Application Publication
(10) Pub. No.: US 2006/0271290 A1
(43) Pub. Date: Nov. 30, 2006

(54) METHOD FOR EXCHANGING ROUTE SCHEMES OF GLOBAL POSITIONING SYSTEM

(76) Inventor: Wei-Tin Li, Taipei County (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(21) Appl. No.: 11/307,549

(22) Filed: Feb. 13, 2006

(30) Foreign Application Priority Data
Mar. 14, 2005 (TW) 94107646

(51) Int. Cl. G01C 21/00

(52) U.S. Cl. 701/213; 701/200

(57) ABSTRACT

A method for exchanging route schemes of a Global Positioning System (GPS) is provided. The method comprises the following steps. First, an ongoing route scheme is planned on a first device. Then, a transmission mode of the first device is activated for outputting the planned route scheme, and a receiving mode of a second device is activated for receiving and executing the planned route scheme. Accordingly, the same route scheme is set for all devices so that the drivers can arrive at the destination according to the same route scheme. Therefore, the unnecessary repetition of the route planning on different devices can be avoided. Thus, a great amount of time is saved.

### CROSS-REFERENCE TO RELATED APPLICATION

This application claims the priority benefit of Taiwan application serial no. 94107646, filed on Mar. 14, 2005. All disclosure of the Taiwan application is incorporated herein by reference.

### BACKGROUND OF THE INVENTION

1. Field of the Invention

The present invention relates to a method for exchanging data, and more particularly, to a method for exchanging route schemes of a Global Positioning System (GPS).

2. Description of the Related Art

Global Positioning System (GPS) comes from a precise satellite navigation and positioning project initialized by U.S. Department of Defense. The GPS system comprises 26 artificial satellites distributed on 6 different orbits separated by 55 degrees from each other. Accordingly, a GPS user can receive signals from 4 to 8 satellites for positioning at anytime and anywhere on the earth without the influence of the weather condition if there is no physical block by the topography or construction.

Originally, the development of the GPS merely served for the military purpose. Now the GPS has been public to civil uses, which makes a revolutionary change in the applications of our daily life. For example, with the GPS navigation and positioning technology, the satellite antenna installed inside the vehicle is incorporated with the embedded database to display the current location on the computer screen, so as to guide the driver while driving. Furthermore, this technology can also be applied to a route scheme selection for the driver, so as to get to the destination in a shorter period of time.

In addition, Geographic Information Service (GIS) is a technique developed for decades, which originally used for the purposes of irrigation, ecology, and meteorology researches. Recently, the GIS technique has been widely applied in the mobile phone in Japan, such that the user with i-mode mobile phone service can find out the current location through the base stations of the mobile phone system. The information of the current location and vicinity will be automatically filtered and downloaded to the user's mobile phone, such that the mobile phone user can obtain any kind of valuable information at anytime and anywhere. Similarly, the domestic GIS service providers have provided various GIS services related to the user's current location, such as the bus information, navigation, e-Map, Point of Interest (POI), house rent, and job searches, etc.

Currently, the domestic GIS vendors are aggressive in cooperating with the telecom vendors for developing Point of Interest (POI) searches such as entertainment and consumption information service. Various GIS-related services, such as e-Map search and consumption information, are provided to the subscribed users via various mobile apparatus. POI may contain various information, such as the longitude, the latitude, and the name of a specific interest point (e.g. information provided by the name of administration district, street, park, government office, restaurant, entertainment, etc.), or even the telephone number of a specific point as well as the introduction of interest point (via text, audio and graphics, etc.).

Nowadays, a consumer can find out the exact location of the point to be visited in advance with the POI information and uses the GPS to plan an ongoing route on the PDA (Personal Digital Assistant), such that the user can arrive at the destination without getting lost, which significantly improves the travel convenience. However, if a group of friends would like to visit a place or get to a destination together from the same location with separate vehicles, in order to ensure that everyone goes on the same route and does not get lost, the driver in each car needs to perform the same route scheme planning operation with PDA. Even though only one ongoing route is required, the same route planning operation has to be respectively and repetitively performed on each PDA, which makes the user who uses the GPS on the PDA feel such system is not user-friendly and very time-consuming.

### SUMMARY OF THE INVENTION

Accordingly, an object of the present invention is to provide a method for exchanging route schemes of a Global Positioning System (GPS). With such method, after an ongoing route is planned on a first device using the GPS, the planned route scheme will be transmitted to a second device via a specific transmission mode that the same route scheme can be used by all devices for getting to the destination. Thus, it is not necessary to perform the same route scheme on different devices.

Another object of the present invention is to provide a method for exchanging route schemes of a GPS. With such method, after an ongoing route is planned on a first device using the GPS, the planned route scheme will be transmitted to a second device via a Bluetooth transmission mode, such that the same route scheme is used by all devices for getting to the destination without the need to perform the same route scheme planning on different devices.

Another object of the present invention is to provide a method for exchanging route schemes of a GPS. With such method, after an ongoing route is planned on a first device using the GPS, the planned route scheme is transmitted to a second device via an infrared transmission mode, such that the same route scheme is used by all devices for getting to the destination without the need to perform the same route scheme planning on different devices.

The present invention provides a method for exchanging route schemes of a GPS. The method comprises the following steps. First, an ongoing route is planned using the GPS on a first device. Then, a transmission mode of the first device is activated for outputting the planned ongoing route. Then, a receiving mode of a second device is activated for receiving and executing the planned ongoing route.

According to an embodiment of the present invention, a message will be displayed on the screen to ask the user whether the ongoing route should be received or not when the second device is ready to receive the ongoing route.

According to an embodiment of the present invention, when the planned ongoing route has been received by the second device, a message indicating the completion of receiving will be displayed on the screen to notify the user that the receiving operation is completed.

According to an embodiment of the present invention, both of the transmission mode and the receiving mode mentioned above use the wireless transmission mode; and the wireless transmission mode may be either the Bluetooth transmission mode or the infrared transmission mode.

According to an embodiment of the present invention, both of the first device and the second device mentioned above are the mobile devices; and the mobile device may be a PDA.

The present invention also provides a method for exchanging route schemes of a GPS. The method comprises the following steps. First, an ongoing route is planned using the GPS on a first device. Then, a Bluetooth transmission mode of the first device is activated for outputting the planned ongoing route. Then, a Bluetooth receiving mode of a second device is activated for receiving and executing the planned ongoing route.

The present invention further provides a method for exchanging route schemes of a GPS. The method comprises the following steps. First, an ongoing route is planned by using the GPS on a first device. Then, an infrared transmission mode of the first device is activated for outputting the planned ongoing route. Then, an infrared receiving mode of a second device is activated for receiving and executing the planned ongoing route.

According to an embodiment of the present invention, a message will be displayed on the screen to ask the user whether to receive the ongoing route or not when the second device is ready to receive the ongoing route.

According to an embodiment of the present invention, when the planned ongoing route has been received by the second device, a message indicating the completion of receiving will be displayed on the screen to notify the user that the receiving operation is completed.

According to an embodiment of the present invention, both of the first device and the second device mentioned above are the mobile devices; and the mobile device may be a PDA.

The present invention applies the method for exchanging route schemes of a GPS. With such method, after an ongoing route is planned on a first device using the GPS, the planned route scheme will be transmitted to a second device via a specific transmission mode, such that the same route scheme is used by all devices for getting to the destination without the need to perform the same route scheme planning on different devices. Accordingly, a great amount of time is saved.

### BRIEF DESCRIPTION OF THE DRAWINGS

The accompanying drawings are included to provide a further understanding of the invention, and are incorporated in and constitute a part of this specification. The drawings illustrate embodiments of the invention, and together with the description, serve to explain the principles of the invention.

FIG. 1 schematically shows a flow chart illustrating a method for exchanging route schemes of a GPS to an embodiment of the present invention.

### DESCRIPTION OF THE EMBODIMENTS

The feature of the method for exchanging route schemes of a GPS provided by the present invention is that only one device is required to perform an ongoing route planning using the GPS; the planned route scheme will be transmitted to a second device via a specific transmission mode, such that the same route scheme is used by all devices for getting to the destination without the need to perform the same route scheme planning on different devices.

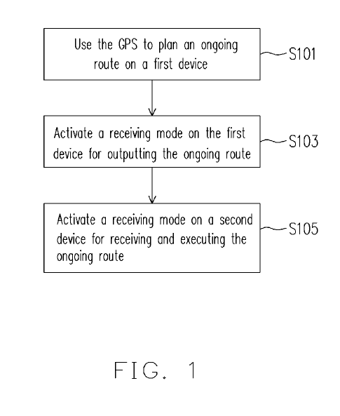

FIG. 1 schematically shows a flow chart illustrating a method for exchanging route schemes of a GPS to an embodiment of the present invention. Referring to FIG. 1, in step S101, an ongoing route is first planned by a user with the GPS on a first device. Then, in step S103, the user activates a transmission mode on the first device for transmitting the ongoing route planned using the GPS.

In step S105, when a second user is ready to use the second device to receive the ongoing route planned on the first device, a receiving mode of the second device is activated to receive the planned route scheme mentioned above. When the planned ongoing route has been received by the second device, a message is displayed on the screen of the second device to notify the user that the transmitting/receiving operation is completed.

In the present embodiment, since the ongoing route is planned using the GPS, the first device and the second device mentioned above may be any device supporting the GPS function, or may be a portable mobile device, such as the laptop or the currently popular PDA. In addition, the first device and the second device in the present embodiment may be different types of devices. For example, the first device may be a laptop, and the second device may be a PDA as long as both the transmission mode and the receiving mode of these two devices are compatible with each other for transmitting and receiving data.

In addition, to facilitate a user's operation, the transmission mode and the receiving mode mentioned above may be wireless transmission mode. In the present embodiment of the present invention, the wireless transmission mode may be Bluetooth or infrared transmission.

The Bluetooth transmission technique is a short distance radio frequency wireless transmission technique cooperatively developed by Intel, Ericsson, Nokia, IBM and Toshiba in May 1998. Up to June 1999, there were 751 members dedicated in promoting the Bluetooth transmission technique. Moreover, a consensus has been achieved among these companies to establish standardization for reducing the technical development cost. The Bluetooth transmission technique therefore can be widely applied in the industry. Accordingly, by applying the Bluetooth transmission technique in the present embodiment of the present invention, the compatibility problem in transmitting data between devices is no longer existed.

In the Bluetooth transmission technique, a miniaturized wireless base band module chip is installed inside the terminal. Due to the easy miniaturization, it is suitable for embedded products to support short distance wireless communication between a desktop and various mobile devices such as the laptops, the PDAs, and the mobile phones. Thus, information transmission among various mobile devices becomes easier. In addition, the maximum distance of the transmission range supported by the Bluetooth transmission technique is up to 10 meters, thus the transmitting/receiving operation performed by the Bluetooth transmission technique will not be impacted by other information device. For example, the ongoing route to be transmitted in the present embodiment may be transmitted via the Bluetooth transmission technique without impacting other devices that are currently operated for the wireless transmission.

Furthermore, the Bluetooth transmission technique transmits data and voice in a frequency of ISM band. Wherein, every device supporting the Bluetooth transmission technique has a standard address, such that the user can use the low power radio to establish a one-to-one or one-to-seven communication link (in such case, a small network is formed). Accordingly, in the present embodiment, if several mobile devices are required for the transmission of the ongoing route planned by the first device at the same time, the Bluetooth transmission technique can be used to establish a one-to-many communication for saving more time.

The Bluetooth transmission technique supports 1 MB/sec of high transmission rate and code encryption by using the PIN code. If it is operated in the Spread-spectrum mode, the frequency for transmitting the data packet is changed 1600 times per sec by the Bluetooth transmission technique. Therefore, in the present embodiment, when the second device is ready to receive the ongoing route planned by the first device, a message is displayed on the screen of the second device to ask the user whether he/she is ready to receive the ongoing route from the first device or not. If the user agrees to receive the ongoing route, an adjustment is performed by the Bluetooth transmission technique, such that the transmitting frequency is synchronized with the receiving frequency for receiving the accurate data.

Besides, the infrared transmission technique also can be applied in the present embodiment in addition to the Bluetooth transmission. Wherein, the specification of the infrared transmission technique is mainly defined by Infrared Data Association (IrDA) which was established in 1993, with more than 160 members in 1999.

In addition, the IrDA also defines a set of standard, where the typical transmission rate is defined as 9.6 kbps˜4 Mbps, such that the infrared transmission provided by the IrDA can be applied on the general mobile phone, the PDA, or the precise instrument where the high frequency wireless transmission cannot be used. Accordingly, by applying the infrared transmission technique in the present embodiment of the present invention, the compatibility problem in transmitting data between devices is no longer existed.

However, the infrared transmission technique is a point-to-point transmission with up to 1.5 meter of transmission distance, and the initial angle of receiving signal is limited by a range of ±15 degrees. In the latest version of specification, the transmission rate is enhanced to 16 Mbps, and the angle of receiving signal is increased to ±60 degrees.

The IrDA is advantageous in its characteristics of low cost, low error rate, high security, low electricity consumption, and low interference, thus a lot of electronic products have embedded IrDA. Moreover, most of laptops have equipped with IrDA as the embedded standard equipment. In addition, the IrDA specification is also supported by most of the Microsoft operating systems (e.g. Win98, WinNT, Win2000, WinXP, and WinCE). Accordingly, it is very convenient to apply the method for exchanging route schemes of a GPS provided by the present invention.

Not only the Bluetooth transmission technique and the infrared transmission technique mentioned above can be used as the transmitting/receiving media, but other wireless transmission techniques can also be used to perform the transmitting/receiving operation, wherein the Wireless Local Area Network (WLAN) is a good example. No matter which type of transmission medium is selected, it should be noted that the data transmission needs to be synchronized with the data receiving, so as to ensure that the second device will receive the accurate ongoing route information.

In summary, with the method for exchanging route schemes of a GPS provided by the present invention, after an ongoing route is planned on a first device by using the GPS, the planned route scheme is transmitted to a second device via a specific transmission mode, such that the same route scheme can be used by all devices for getting to the destination without repetitively performing the same route scheme planning on different devices. Thus, the time is saved.

Although the invention has been described with reference to a particular embodiment thereof, it will be apparent to one of the ordinary skill in the art that modifications to the described embodiment may be made without departing from the spirit of the invention. Accordingly, the scope of the invention will be defined by the attached claims not by the above detailed description.

What is claimed is:

1. A method for exchanging route schemes of a Global Positioning System (GPS), comprising:
using the GPS to plan an ongoing route on a first device;
activating a transmission mode on the first device for outputting the ongoing route; and
activating a receiving mode on a second device for receiving and executing the ongoing route.

2. The method of exchanging route schemes of the GPS of claim 1, wherein when the second device is ready to receive the ongoing route, a message is displayed to ask the user whether to receive the ongoing route or not.

3. The method of exchanging route schemes of the GPS of claim 1, wherein when the planned ongoing route has been received by the second device, a message indicating the completion of receiving is displayed.

4. The method of exchanging route schemes of the GPS of claim 1, wherein both of the transmission mode and the receiving mode use wireless transmission mode.

5. The method of exchanging route schemes of the GPS of claim 4, wherein the wireless transmission mode is a Bluetooth transmission mode.

6. The method of exchanging route schemes of the GPS of claim 4, wherein the wireless transmission mode is an infrared transmission mode.

7. The method of exchanging route schemes of the GPS of claim 1, wherein the first device is a mobile device.

8. The method of exchanging route schemes of the GPS of claim 7, wherein the mobile device is a personal digital assistant (PDA).

9. The method of exchanging route schemes of the GPS of claim 1, wherein the second device is a mobile device.

10. The method of exchanging route schemes of the GPS of claim 9, wherein the mobile device is a PDA.

11. A method for exchanging route schemes of a Global Positioning System (GPS), comprising:
using the GPS to plan an ongoing route on a first device;
activating a Bluetooth transmission mode on the first device for outputting the ongoing route; and
activating a Bluetooth receiving mode on a second device for receiving and executing the ongoing route.

12. The method of exchanging route schemes of the GPS of claim 11, wherein when the second device is ready to receive the ongoing route, a message is displayed to ask the user whether to receive the ongoing route or not.

13. The method of exchanging route schemes of the GPS of claim 11, wherein when the planned ongoing route has been received by the second device, a message indicating the completion of receiving is displayed.

14. The method of exchanging route schemes of the GPS of claim 11, wherein the first device is a mobile device.

15. The method of exchanging route schemes of the GPS of claim 14, wherein the mobile device is a PDA.

16. The method of exchanging route schemes of the GPS of claim 11, wherein the second device is a mobile device.

17. The method of exchanging route schemes of the GPS of claim 16, wherein the mobile device is a PDA.

18. A method for exchanging route schemes of a Global Positioning System (GPS), comprising:
using the GPS to plan an ongoing route on a first device;
activating an infrared transmission mode on the first device for outputting the ongoing route; and
activating an infrared receiving mode on a second device for receiving and executing the ongoing route.

19. The method of exchanging route schemes of the GPS of claim 18, wherein when the second device is ready to receive the ongoing route, a message is displayed to ask the user whether to receive the ongoing route or not.

20. The method of exchanging route schemes of the GPS of claim 18, wherein when the planned ongoing route has been received by the second device, a message indicating the completion of receiving is displayed.

21. The method of exchanging route schemes of the GPS of claim 18, wherein the first device is a mobile device.

22. The method of exchanging route schemes of the GPS of claim 21, wherein the mobile device is a PDA.

23. The method of exchanging route schemes of the GPS of claim 18, wherein the second device is a mobile device.

24. The method of exchanging route schemes of the GPS of claim 23, wherein the mobile device is a PDA.
